(19) United States
(12) Patent Application Publication
(10) Pub. No.: US 2011/0271730 A1
(43) Pub. Date: Nov. 10, 2011

(54) APPARATUS FOR AND METHOD OF MANUFACTURING A HELICALLY WOUND TUBULAR STRUCTURE

(75) Inventor: Richard Martin Curtis, Lawford (GB)

(73) Assignee: ITI SCOTLAND LIMITED, GLASGOW (GB)

(21) Appl. No.: 13/144,826

(22) PCT Filed: Jan. 14, 2010
(86) PCT No.: PCT/GB10/50056

§ 371 Date: Jul. 15, 2011

(30) Foreign Application Priority Data
Jan. 16, 2009 (GB) 0900723.8

(51) Int. Cl. B21C 37/12; B29C 53/68; B65H 20/06; B21C 49/00

(52) U.S. Cl. 72/142

(57) ABSTRACT

A winding apparatus for and method of manufacturing helically wound structures (116) includes a rotating faceplate (74) upon which are mounted a forming station for forming a supply of strip material before it is wound into a desired structure, a plurality of inner supports in the form of rollers (110) mounted for rotation about an axis and with said faceplate and a plurality of outer driven rollers (92) provided on an outer faceplate (118). In operation, the inner rollers act to support an inner portion S1 of strip material wound thereon whilst allowing it to be supplied from an inner diameter thereof to said forming station and the outer rollers (92) act to support an outer portion S2 of said strip. Said outer rollers are driven as and when necessary to transfer material to the inner portion S1.

### CROSS-REFERENCE TO RELATED APPLICATIONS

This application is a United States national phase application under 35 U.S.C. §371 of International Patent Application No. PCT/GB2010/050056 filed on Jan. 14, 2010, and claims the benefit of Great Britain Patent Application No. 0900723.8 filed on Jan. 16, 2009, both of which are herein incorporated in their entirety by reference. The International Application was published as International Publication No. WO 2010/082060 on Jul. 22, 2010.

### FIELD

The present invention relates to a winding apparatus and a method of manufacturing structures and relates particularly to the manufacture of pipes and longitudinal structures formed by winding strips of material, such as metal, Kevlar, plastic, glass fibre, composites of such materials or strips formed from layers comprising one or more of said materials in a helical relationship. Other structures such as storage vessels, towers and support structures may also benefit from features described herein.

### BACKGROUND

Presently it is known to manufacture tubular structures by winding pre-formed metal strip onto a rotating mandrel such that the strip is deposited onto the mandrel in a self-overlapping manner. The strip is retained in place by mechanical deformation of an edge thereof such that it interlocks with an adjacent edge, thereby to retain the strip in place on the final structure. EP0335969 discloses an apparatus for forming a helically wound tubular structure formed from a flat strip of metal wound onto a mandrel. The flat strip is fed from one or other of a pair of supply spools mounted concentrically with the axis of the tubular structure to be made. A rotating winding head is used to wind the strip onto the mandrel and includes a plurality of powered forming rollers which impart an initial form to the cross section of the metal strip before it is passed to a final set of rollers that lay the strip onto the mandrel. An edge of the strip is then swaged over so that it becomes mechanically locked to the previous layer over which it is wound. This is a complex process. Also provided is a mechanism for ensuring the strip supply is maintained constant and this mechanism includes speed control of the forming rollers. The coaxial supply bobbins are fed from an external supply spool so as to maintain the supply thereof. A welding station is used to join one end of the strip material to another.

U.S. Pat. No. 4,738,008 discloses a winding apparatus for forming a non-rotating helix of metal strip having a rotating store of metal strip provided radially outward of a winding head and means for providing the store of material to the winding head which rotates at a different speed to the store of material. In this process it is necessary to stop the process when the strip material has been consumed and a fresh supply thereof is added before production can be commenced. This can be a very lengthy process.

### SUMMARY OF THE INVENTION

It is an object of the present invention to provide an apparatus for and method of manufacturing tubular structures which reduces and possibly overcomes some of the problems associated with the prior art.

Accordingly, the present invention aims to reduce the problems associated with the prior arrangements by providing a winding apparatus comprising an inner faceplate rotatably mounted for rotation about a longitudinal axis X-X and having an output station thereon; and an outer faceplate radially outward of said inner faceplate; wherein said inner faceplate includes a plurality of inner strip supports at an outer diameter thereof and onto which, in operation, a supply of material may be wound, said outer faceplate includes a plurality of outer supports for supporting a supply of strip material and further includes a drive mechanism for rotating a supply of strip material about said longitudinal axis X-X. Such an arrangement allows for the replenishment of material whilst the production process is in process and also allows for the speedy replenishment of material when the process is stopped.

Preferably, said inner strip supports comprise a plurality of rollers mounted for rotation about a roller axis R.

Advantageously, said strip driving mechanism comprises a plurality of driven rollers at an outer diameter of said second faceplate which, in operation, engage with an outer diameter of a supply of strip material supplied to said apparatus. The driven rollers may also comprise the outer supports.

Advantageously, the apparatus further includes a strip brake for preventing rotation of an outer diameter of any strip material supplied to said apparatus relative to said inner faceplate. The brake may comprises a friction brake and may even comprise a driven roller having a brake system. If said strip brake comprises a plurality of driven rollers one or more of said rollers may include a brake mechanism for engagement with an outer diameter of any strip material wound onto said outer faceplate.

Preferably, said rollers comprise bi-directional rollers and further include a drive mechanism for driving said rollers in both directions around said axis R.

Advantageously, said drive mechanism includes a brake.

Conveniently, said apparatus further includes a pair of feed rollers mounted on an outer diameter of said outer faceplate for receiving a supply of strip material to said apparatus and for guiding said strip towards said inner faceplate.

Preferably, said apparatus further includes a strip clamping and cutting station.

In one arrangement said inner faceplate further includes a central bore for receiving a supply of core material onto which strip supplied to said apparatus may be wound and may further include a core supply mechanism for supplying a continuous or semi-continuous supply of core material to said apparatus.

According to a further aspect of the present invention there is provided a method of forming a tubular article on an apparatus comprising an inner faceplate rotatably mounted for rotation about a longitudinal axis X-X and having an output station thereon; and an outer faceplate radially outward of said inner faceplate; wherein said inner faceplate includes a plurality of inner strip supports at an outer diameter thereof and onto which, in operation, a supply of material may be wound, said outer faceplate includes a plurality of outer supports for supporting a supply of strip material and further includes a drive mechanism for rotating a supply of strip material about said longitudinal axis X-X, the method comprising the method comprising the steps of:
i. winding a supply of strip material onto said inner supports;
ii. passing a supply of said strip material from an inner diameter thereof through said inner supports to an inner diameter of said inner faceplate; and
iii. rotating said faceplate so as to cause said strip material to be so transferred.

When said apparatus includes a strip forming station on said inner faceplate, said method preferably includes the step of supplying said strip to said forming station and causing formed strip to be deposited in a spiral fashion so as to form a tubular structure.

When said outer rollers are driven rollers the method preferably includes the step of driving said rollers at a speed greater than that of the inner faceplate so as to cause the removal of strip material from an outer diameter S2 thereof and deposit it at an inner diameter S1 supported by said inner supports.

When said apparatus further includes a strip clamp at an outer diameter of said apparatus the method preferably includes the further step of slowing the outer diameter S2 and then reversing it so as to allow an otherwise free end of said strip material to be fed back into said clamp and joining a fresh supply of strip material to said otherwise free end.

Advantageously, the method includes the further step of releasing said clamp and causing fresh material to be added to said inner diameter S1 by rotating said inner faceplate.

### BRIEF DESCRIPTION OF THE DRAWINGS

The present invention will now be more particularly described by way of example only with reference to the accompanying drawings in which:

FIGS. 1 to 3 are partial cross-sectional views of different types of tubular structure that may be formed by the apparatus described herein;

FIG. 4 is a schematic side elevation of an apparatus according to aspects of the present invention;

FIG. 5 is a cross-sectional view of the winding head according to one aspect of the present invention;

FIG. 6 is a front view of the forming head shown in FIG. 5 and for reasons of clarity omits some features shown in FIG. 5;

FIG. 7 is a detailed front view of the winding head taken in the direction of arrow A in FIG. 5; and

FIGS. 8 to 18 are end views of the winding head and illustrate various stages in the operation thereof.

### DESCRIPTION OF THE EMBODIMENTS

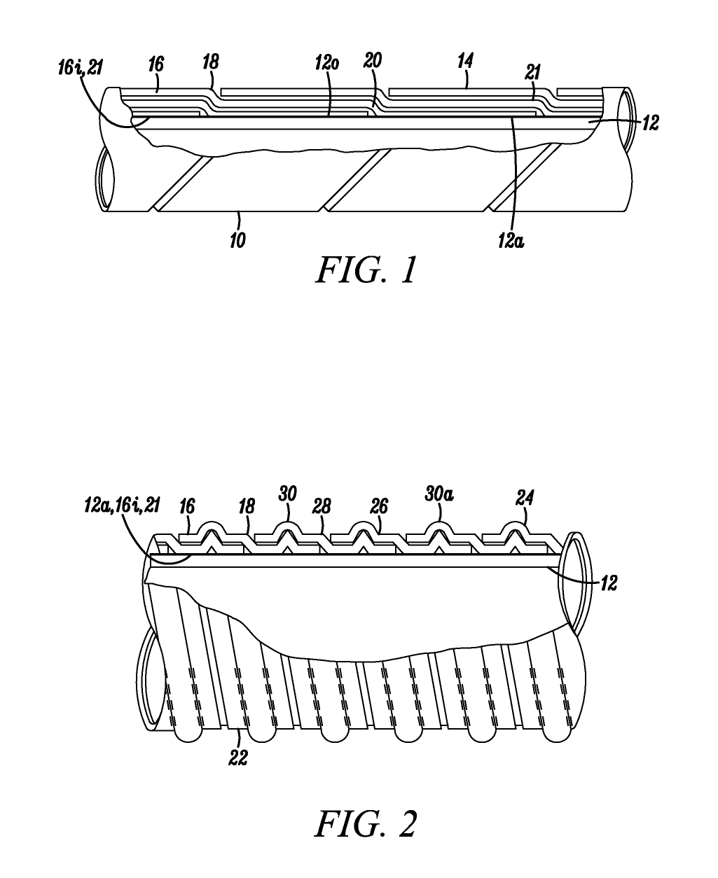

Referring now to FIG. 1 of the drawings, a tubular body indicated generally at 10 forms a pipe for use in a pipe system such as a pipeline carrying hot fluids (which may also be under pressure). The tubular body may comprise an inner portion in the form of an inner hollow core 12 which may be formed by any one of a number of forming processes known to those skilled in the art and an outer load carrying casing discussed in detail later herein and which may also be load carrying. In the preferred process the inner pipe comprises a continuously formed core, as will also be discussed in detail later herein however, one may have a core made from a plurality of discrete lengths inter-engaged with each other so as to form a long length. The outer casing indicated generally at 14 is formed on the inner hollow core 12 by helically winding a strip 16 of material onto the outer surface 12a of the core 12 in abutting or self-overlapping fashion similar to the manner which is described in detail for the formation of a pipe on a mandrel in the specific descriptions of the applicants U.K. Patent No. 2,280,889 and U.S. Pat. No. 5,837,083. The strip may be wound under tension and may have one or more transverse cross-sectional steps 18 and 20 each of which is preferably of a depth corresponding to the thickness of the strip 16. The steps 18, 20 are preferably preformed within the strip 16, each extending from one end of the strip 16 to the other to facilitate an over-lapping centreless winding operation in which each convolution of the strip accommodates the overlapping portion of the next convolution. Whilst the strip may comprise any one of a number of materials such as a plastic, a composite material or indeed metal, it has been found that metal is particularly suitable in view of its generally high strength capability and ease of forming and joining as will be described later herein. Examples of suitable metals include steel, stainless steel, titanium and aluminum, some of which are particularly suitable due to their anti-corrosion capabilities. The internal surface 16i of the strip 16 and the outer surface of the pipe 12o may be secured together by a structural adhesive, as may the overlapping portions 16a of the strip. The use of an adhesive helps ensure that all individual components of the tubular member 10 strain at a similar rate. The application of the adhesive may be by any one of a number of means but one particularly suitable arrangement is discussed in detail later herein together with a number of other options.

FIG. 2 illustrates an alternative arrangement in which the flat strip 16 is formed such that step 28 divides the strip into longitudinal portions and is also provided with ridges 30 running longitudinally thereof. The ridges are shaped to produce an external ridge and an internal groove into which an external ridge of a previously deposited portion nestles during forming.

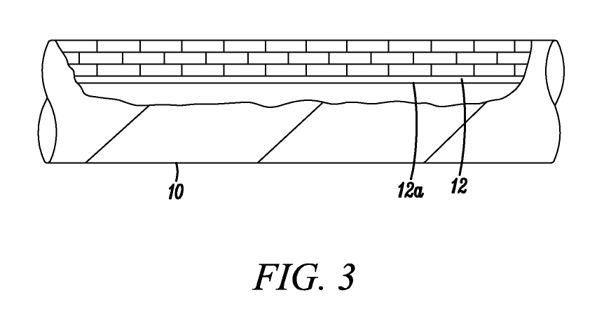

FIG. 3 illustrates a still further arrangement in which the strip comprises a simple flat strip wound in abutting relationship and provided in multiple layers which may be staggered as shown.

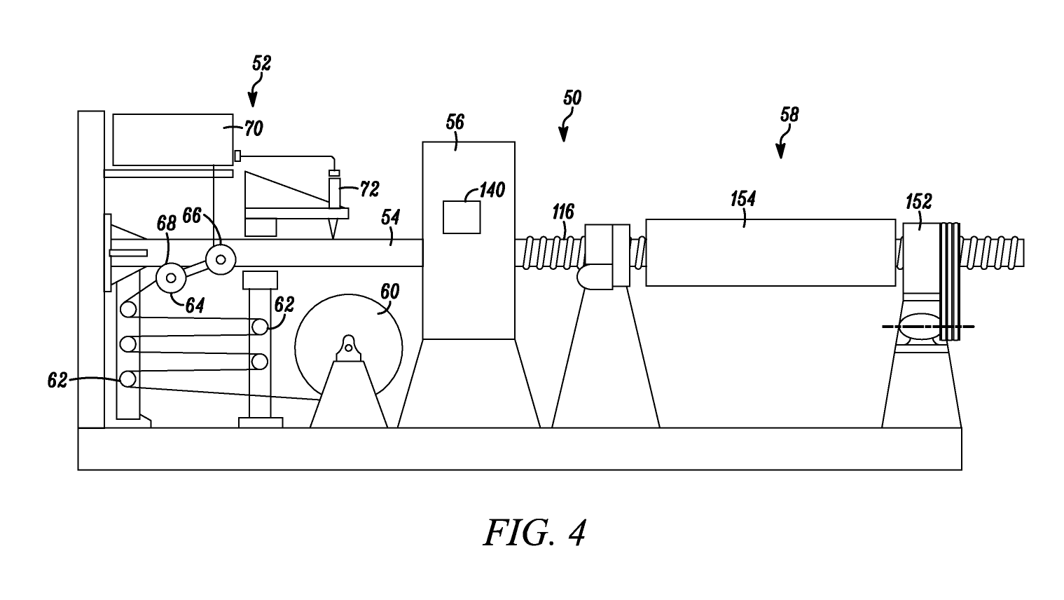

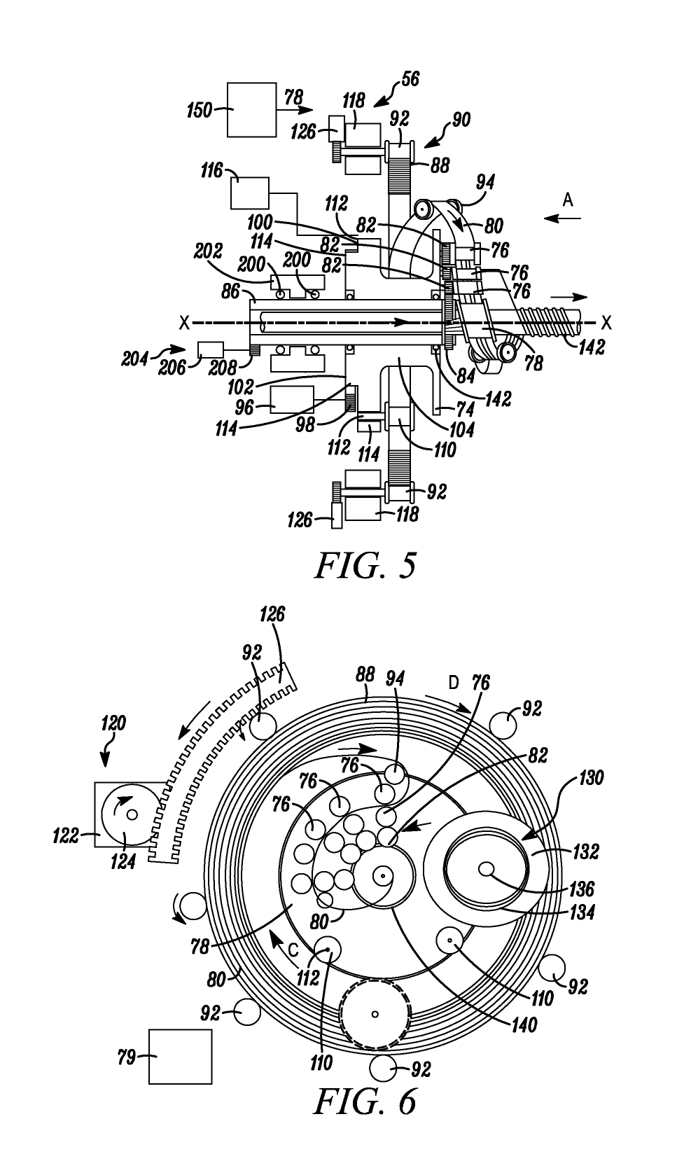

Referring now more particularly to FIG. 4, from which it will be seen that an apparatus 50 for manufacturing helically wound structures comprises: an optional pre-forming portion 52, in which a core 54 is formed; a forming station, shown schematically at 56 and described in detail later herein; and a post forming section, shown generally at 58 and including a number of optional features discussed later. In one arrangement of the optional pre-forming portion 52 there is provided a store of flat strip material in the form of a roll of metal strip 60 and a plurality of feed rollers 62 which feed the strip to forming rollers 64 and 66 which in turn roll the edges of the strip together around a central mandrel 68 so as to form a tubular structure 54 having confronting edges abutting each other (not shown). A welding apparatus shown generally at 70 and including a welding head 72 is used to weld together the confronting edges in a manner well known in the art and therefore not described further herein. An alternative core forming process might comprise the manufacture of a plurality of discrete lengths of tubular structure, each of which are provided with inter-engaging features on confronting ends thereof such as to allow a plurality of said lengths to be assembled into a long section of core. When employing such a core arrangement one may replace the strip forming and welding arrangement with a suitable feed mechanism (not shown) for feeding a plurality of said discrete lengths into the forming station in a continuous manner. Once formed, the core of whatever description is fed into the forming station 56, which is best seen with reference to FIGS. 5 and 6.

In order to ensure an even feed of strip material from a supply thereof it may be desirable to provide a supply thereof in the form of stock supply 88. Advantageously this stock supply may be provided in a cassette or stock support 90 comprising a plurality of support rollers 92 positioned outside of said forming station and being circumferentially spaced around longitudinal axis X. Said support rollers 92 cooperate with a outer portion S2 of the stock of strip material 88 and allows the stock to rotate in the direction of arrow D about axis X. The strip material 80 is removed from an inner diameter of said stock thereof and fed via a first strip supply guide roller 94 mounted for rotation on said faceplate 74 about an axis angled relative thereto. In order to drive the faceplate 74 one may provide a motor 96 and gear drive 98 coupled to a ring gear 100 provided on a back plate 102 which is directly linked to face plate 74 via annular portion 104 through which non rotating portion 86 extends. Also shown in FIGS. 4 and 5 are a plurality of inner strip supports in the form of a plurality of rollers 110 provided at an outer diameter of said inner faceplate 74. The rollers of FIG. 4 are rotationally mounted to the inner faceplate 74 by means of rolling pins 112 which are circumferentially spaced around the circumference thereof and mounted for rotation in corresponding holes shown at 114. Whilst the operation of these rollers will be described in more detail later herein, it will be appreciated that the rollers are each fixed radially to rotate about the axis of the pin and thus supporting or guiding inner portion S1 of the supply of strip material 88 as it is consumed from an inner diameter. Referring now once again to FIGS. 5 and 6 from which it will be appreciated that the outer support rollers 92 are mounted in circumferentially spaced relationship around an outer faceplate 118 and may be provided with a drive mechanism shown generally at 120 in FIG. 6 and seen in part in FIG. 5. The drive mechanism comprises a motor or servo mechanism 122 having a gear 124 which drives ring gear 126 which is coupled to the outer support rollers so as to drive said rollers as and when desired. Other forms of drive mechanism will present themselves to those skilled in the art and include but are not limited to direct drive mechanisms such as individual motors and possibly a collective drive mechanism employing a chain drive, neither of which are shown. In operation the motor 122 drives gear 124 which turns 126 which drives rollers 92 which in turn drive the outer diameter of the strip material in the direction of arrow D in FIG. 6.

The diameter defining roller arrangement seen generally at 78 which, between them, act to curve the strip material by plastically deforming it around one of the rollers such as to define the diameter of the exiting strip are not central to the present application and the reader's attention is drawn to the present applicant's patent application PCT/GB2006/050471 which describes this feature in detail. An optional adhesive applicator 130 may also be mounted on the faceplate 74 for rotation therewith. The applicator may take a number of forms for supplying adhesive to the strip after it has been formed and one particular arrangement is shown in which a storage cassette 132 is provided with a roll of adhesive strip 134. The storage cassette 132 is mounted for rotation about a spindle 136 mounted on the faceplate 74 for rotation therewith such that, upon rotation of the faceplate, adhesive strip may be dispensed onto the surface of the strip 80 as it is lain down onto the core 54 (FIG. 5). The strip of adhesive may be provided in the form of a strip having a backing (not shown) and this backing may be removed by backing removing means (not shown) prior to said adhesive being applied. It will be appreciated from the cross-sectional view of FIG. 5 that the faceplate 74 includes a central hole 140 for receiving a core or liner 54 onto which said strip material 80 may be wound so as to form a final structure 142. The central hole may be provided with a central support trunion 86 having a hollow centre which defines said central aperture 140 for receiving said core or liner 54. When provided, the trunion may be mounted within said central hole 114 by means of bearings 142, such that said faceplate 74 can rotate about said trunion 86. Referring now once again to FIG. 4, an optional post forming section 58 may include such things as an optional drive mechanism 152 and adhesive curing heater 154.

Referring to the drawings in general, it will be appreciated that a tubular structure may be manufactured by causing the faceplate 74 to rotate. This action in turn will cause the strip material 80 to be drawn from the cassette, passed through forming rollers 76 and into diameter defining rollers 78 at which point the desired diameter is formed by appropriate positional control of the diameter defining rollers 78. As the strip exits the diameter defining rollers it is directed towards the core 54 and wrapped therearound in a self overlapping or abutting relationship as shown in FIGS. 1 to 3. Before the strip is finally deposited onto the core it may be supplemented by an adhesive dispensed as a strip thereof from dispenser 130. Continuous rotation of faceplate 74 will cause continuous deformation and deposition of the strip 80 and this process will continue so long as there is a supply of strip material within the cassette store. Once the strip material has been depleted it is necessary to transfer fresh material onto the apparatus from a supply station (not shown) and weld one end to the other before recommencing operations. This process is described in detail later herein. It will also be appreciated that some forms of structure need not have a core and the above process may be undertaken without a core being supplied to the faceplate. In such an arrangement it may be necessary to provide a support to the initial portion of tubular structure formed but once an initial portion has been formed the structure will be self supporting as new layers are effectively deposited down on a stable multi layer structure. Indeed, one may well adopt such an arrangement when it is desirable to form a tapered structure for which one would find it difficult to produce a tapered inner core. Structures without cores are, therefore, within the scope of the present invention. In the production of such a tapered structure it is simply necessary to vary the degree of bending applied to the strip, modify the helix angle of the strip as it is laid down onto the former and re-aligning the forming and diameter defining rollers, the latter of which can be done by applying a variable force to the diameter defining rollers 78 so as to change the rolling radius as required. This process may be controlled by the computer shown schematically at 150 in accordance with a pre-determined control methodology.

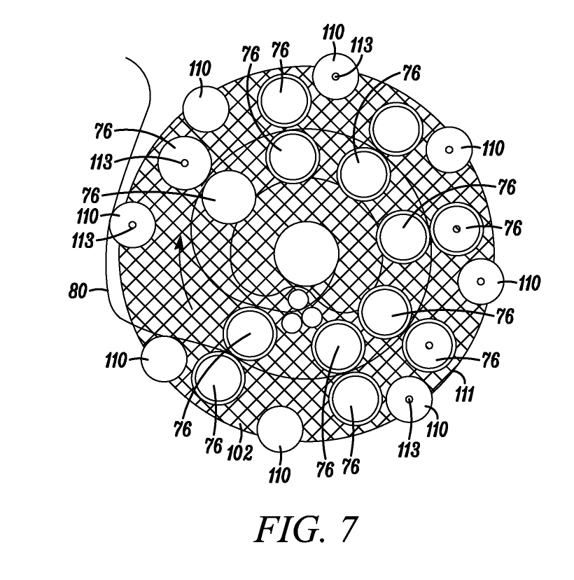

Referring now briefly to FIG. 7 which illustrates the inner support rollers in more detail, it will be appreciated that, whilst the location and support may take any one of a number of forms, the arrangement of FIG. 7 is particularly compact and allows the diameter of the structure to be kept to a minimum. The features of FIG. 7 that might possibly not be appreciated from FIG. 5 include the way in which the rollers 110 project radially slightly beyond the forming rollers 76 and possibly also the outer diameter 111 of the inner portion 102 and are spaced around the circumference thereof so as to provide substantially even support for the strip 88. Additionally, it will be further appreciated that a compact design may be formed by nestling the forming rollers 76 between adjacent support rollers 110. Still further, it will be appreciated that the strip 88 is fed from the inner diameter of the supply thereof and passes between two of said support rollers 110 and around one thereof as it is supplied to the first of the forming rollers 76. One of said rollers acts as a guide roller as shown in FIG. 9. The primary function of the inner support rollers 110 is to provide a support mechanism onto which the strip material 88 may be wound and through which it may be dispensed to the winding head. Each roller 110 is mounted for rotation on a spindle 113 which is, in turn, mounted on the inner portion 102. In operation, strip material may roll over rotating inner rollers 110 as it is supplied to the winding station.

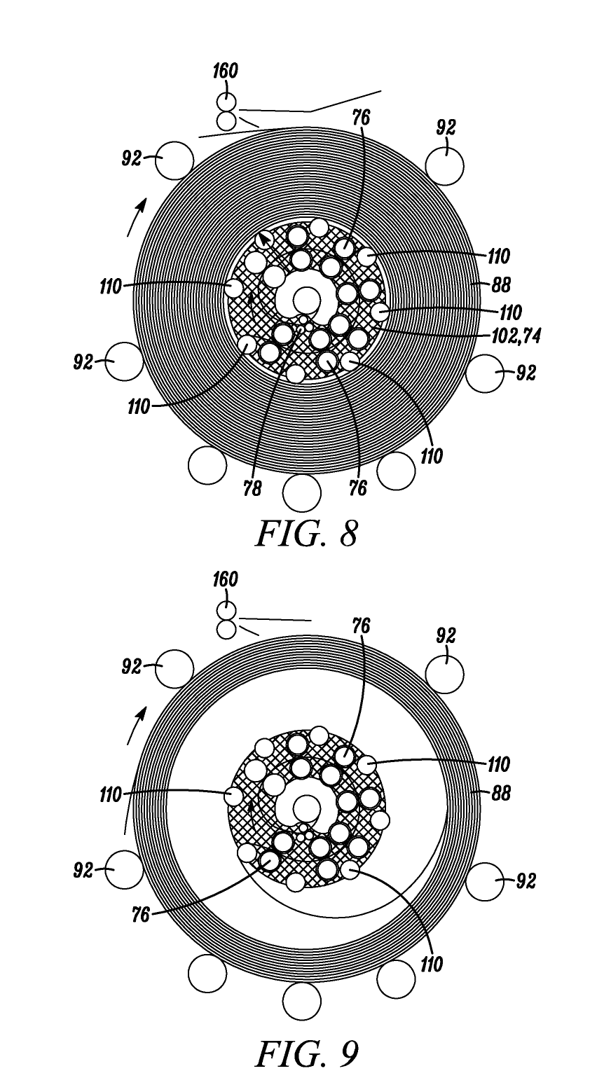

It will be appreciated that whilst the inner rollers 110 and the faceplate 74 are shown in two different planes in FIG. 5 they may be provided in the same plane. In such an arrangement the forming rollers 76 and diameter defining rollers 78 are simply provided at a diameter smaller than that of the support rollers 110, as shown in FIG. 7. FIGS. 8 to 19 illustrate a set of clamp/feed rollers 160 positioned at an outer diameter of the winding head, the function of which will be described later herein.

The various stages of the winding process and replenishment steps will now be more particularly described with reference to FIGS. 8 to 18. In FIG. 8 there will be seen a completely wound supply of strip material 88 which has been wound onto the winding head by rotating inner faceplate 74 (at and thereby drawing a length of strip material onto the inner rollers 110). This process is continued until the space between the inner and outer rollers 110, 92 is filled, at which point the apparatus is ready to commence pipe production. During the “winding on” process it is also possible to produce an amount of pipe as the required material is taken from an inner diameter of the coil of material 88 and this process may be accommodated even during replenishment. It will be appreciated that by virtue of the difference in diameters of the pipe and that defined by the outer crests of the inner support rollers material will be consumed by the forming station at a much lower rate than it will be added to the support rollers 110. Alternatively, one may clamp the strip material so as to prevent it being supplied to the forming rollers and simply complete the re-stocking thereof. Strip material is supplied to the forming station by allowing it to roll over rollers 110 as it spools off the inner diameter of the stock thereof. In this mode one of the inner rollers also acts as a reversal roller allowing the strip material to be turned back on itself in order to direct it directly into the mouth of the first of the forming rollers 76.

FIG. 9 illustrates the next step in the process at which point several meters of strip material has been wound onto the former so as to produce a section of pipe and a significant amount of material 88 has been removed from the inner diameter. There is a difference between the speed of rotation of the coil and that of the winding head and, consequently, as the strip material is consumed a gap opens up between the inner rollers 110 and the bulk of the strip supply and the inner rollers no longer act to support the strip which is now solely supported at its outer diameter by rollers 92.

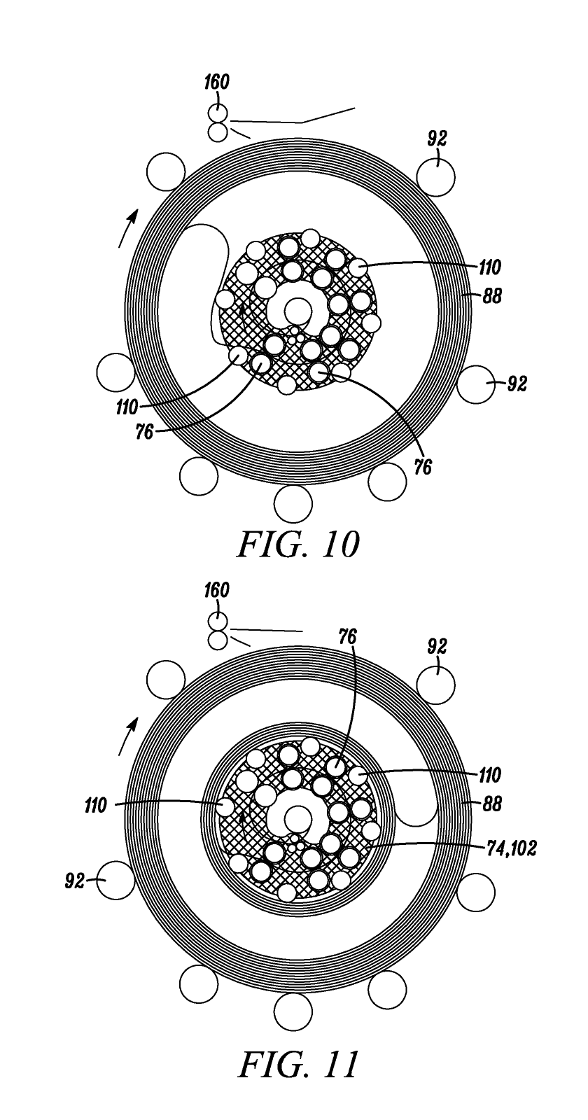

FIG. 10 illustrates the commencement of a building step in which material is added to the inner rollers 110. At this point the outer diameter S2 of material 88 is accelerated to, for example, 120 RPM and the inner winding head speed is maintained at a normal or slightly reduced production speed of, for example, 60 RPM such as to continue producing a pipe. By increasing the speed of S2 one is able to transfer strip material from outer portion S2 to the inner rollers where it forms an inner portion S1, best seen in FIG. 11.

FIG. 11 illustrates the next step in which S2 is slowed to zero and then reversed such as to allow the free end 88a to be reversed into clamp/feed rollers 160 in readiness for a welding step which is completed over the following few steps. Welding takes place whilst S2 is maintained stationary by braking rollers 92 and allowing S1 to be depleted from the inner diameter thereof so as to supply the forming rollers. The outer diameter of S1 is replenished by virtue of the differential speed between it and the stationary inner diameter of S2. The concentricity of S1 is no longer defined at this point.

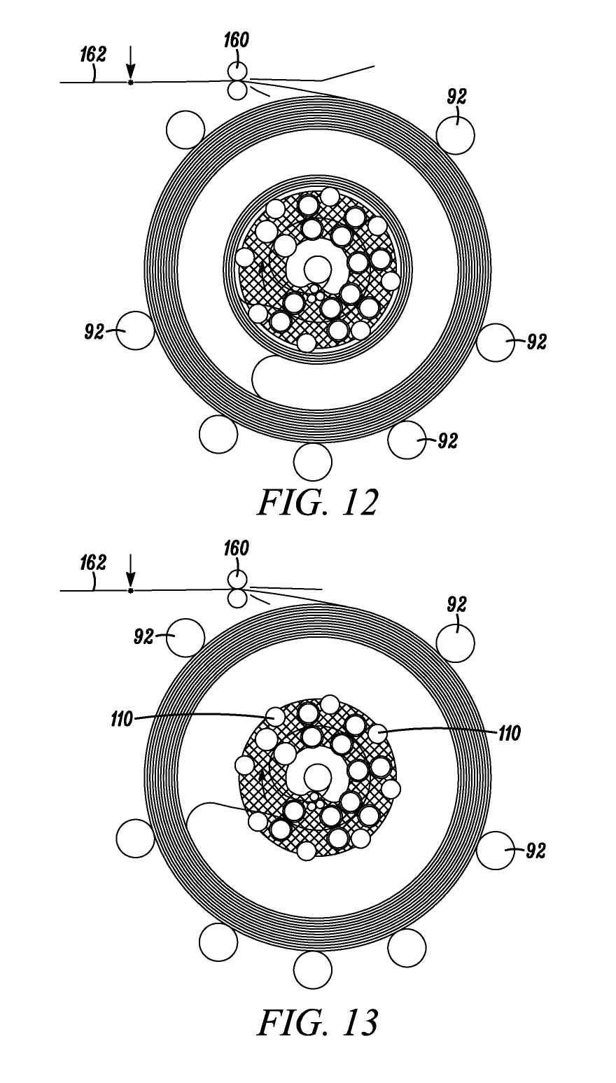

FIG. 12 illustrates the arrangement where the free end 80a has been fed back through the clamp rollers 160 to allow the end to be joined by welding to a fresh supply thereof 182.

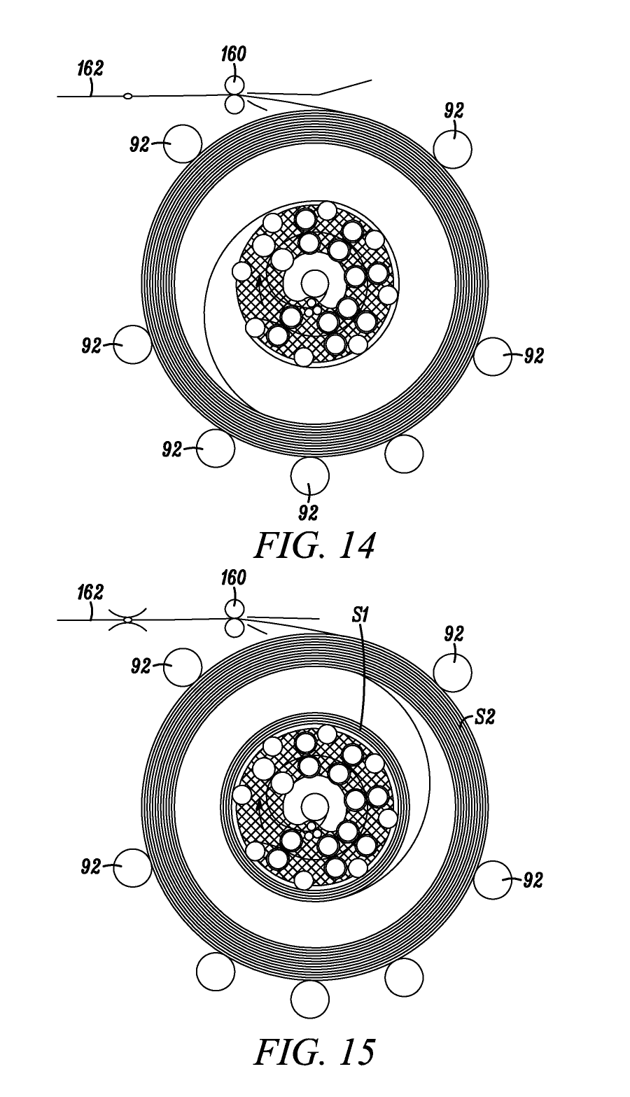

FIGS. 13 and 14 illustrate the depletion of material from S1 and how the supply of material is switched from S1 to the inner diameter of S2. During steps 12 to 14 the otherwise free 88a end of strip 80 is secured in clamp/transfer rollers 160 and welded to the front end of a fresh supply thereof 162 before the weld is dressed and the joined ends are ready to be fed past rollers 160. FIGS. 14 to 16 illustrate the replenishment of S1 from the inner diameter of S2 which continues until S2 is nearly exhausted, at which point the welding will have been completed.

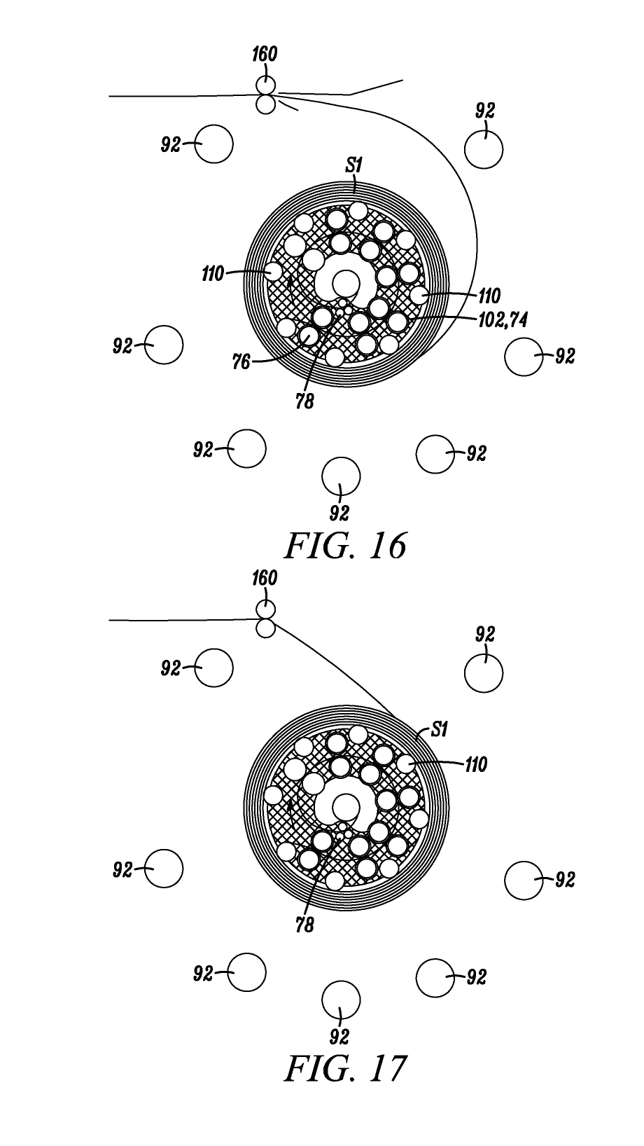

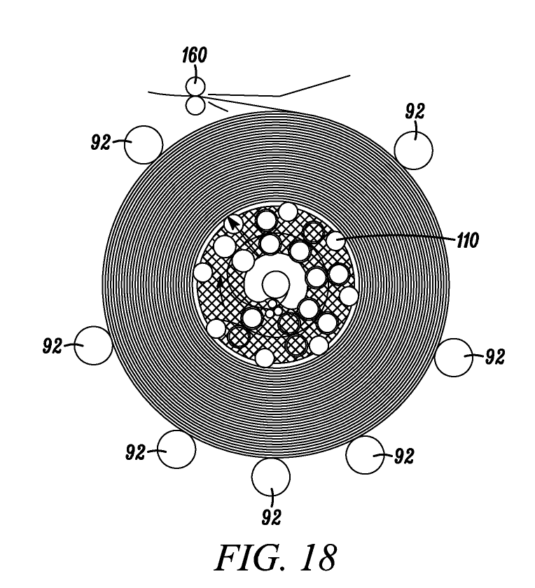

Upon reaching the arrangement of FIG. 16, one may release the clamp 160 and thereby allow fresh material to be drawn onto the already existing (now inner) supply of material at S1. FIGS. 17 and 18 illustrates the refreshing step in which new strip material continues to be supplied to S1 until the gap between it and the outer rollers 92 has been filled. At this point the supply of strip material is stopped, the strip is cut at clamp 160 and the new free end 88a is allowed to pass through clamp rollers 160 such that it is free to rotate with the stock of material 88, as shown in FIG. 8. Alternatively, if done quickly, a fresh strip of material may be joined on without stopping S2. The above sequence of steps is repeated as often as necessary until the desired length of pipe has been produced.

Additional features of this machine include feedback control from the computer to ensure the product diameter is maintained within desired limits and/or altered according to desired parameters. It will be appreciated that as one can control the degree of plastic deformation of the strip as it passes through the radius forming rollers one can also control the final diameter of any tubular structure formed by this apparatus.

It will be appreciated that the described arrangement ensures an even supply of material. It also forms a complex interlocking profile in the material and winds the material onto a core at predetermined curvature, thereby providing a robust structure in the final windings as well as a suitable tensile compression.

It will also be appreciated that the apparatus may be used on strips of other materials such as Kevlar, plastic, glass fibre, composites of such materials or strips formed from layers comprising one or more of said materials. Indeed the machine lends itself particularly to use with some of these materials as it is able to pre-tension the strip as it is wound onto the final form of the tubular structure being formed. When used with composite materials having a portion of metal in the strip provided either as a layer or as part of any woven form thereof, said metal will act to maintain a degree of rigidity in the strip that will assist with the location thereof on the rollers and in maintaining a final curvature. Materials such as glass-fibre or Kevlar may be reinforced by a resin or other such material in the manner well known to those skilled in the art and, therefore, not described further herein. Clearly, any such materials may simply be wound into the desired shape without needing to be provided with a cross-sectional profile as described earlier herein.

Additionally, this arrangement advantageously provides a means of continuous or near continuous supply of winding material. Downtime for reloading of the apparatus with new stock is reduced, thereby also facilitating greater uniformity of the helical winding produced.

It will also be appreciated that the above described method and apparatus may be used to cover an already existing pipeline with an outer casing. In this arrangement the already existing pipeline forms a core and the machine simply rotates around the core and moves therealong so as to lay down the outer wrap of strip material onto the pipeline. Such an approach could be employed when one wishes to repair or strengthen an already existing pipeline.

Still further, it will be appreciated that if portion 86 (FIG. 5) is driven then it may benefit from being separately supported for rotation in bearings 200 provided in a fixed structure 202 and further provided with a drive mechanism shown generally at 204 and including, for example, a motor 206, driving gear 208 and driven gear 210, the latter of which is provided on portion 86. Preferably, the controller is also connected to the motor for control thereof and for this purpose one may also provide control line 212 shown generally in FIG. 6.

What is claimed is:

1. A winding apparatus comprising:
an inner faceplate rotatably mounted for rotation about a longitudinal axis X-X and having an output station thereon; and
an outer faceplate radially outward of said inner faceplate;
wherein said inner faceplate includes a plurality of inner strip supports at an outer diameter thereof and onto which, in operation, a supply of material may be wound, said outer faceplate includes a plurality of outer supports for supporting a supply of strip material and further includes a drive mechanism for rotating a supply of strip material about said longitudinal axis X-X.

2. A winding apparatus as claimed in claim 1 wherein said inner strip supports comprise a plurality of rollers mounted for rotation about a roller axis R.

3. An apparatus as claimed in claim 1 wherein said strip driving mechanism comprises a plurality of driven rollers at an outer diameter of said second faceplate which, in operation, engage with an outer diameter of a supply of strip material supplied to said apparatus.

4. An apparatus as claimed in claim 3 wherein said driven rollers also comprise the outer supports.

5. An apparatus as claimed in claim 1 wherein the apparatus further includes a strip brake for preventing rotation of an outer diameter of any strip material supplied to said apparatus relative to said inner faceplate.

6. A winding apparatus as claimed in claim 5 wherein said strip brake comprises a friction brake.

7. A winding apparatus as claimed in claim 5 wherein said brake comprises a driven roller having a brake system.

8. A winding apparatus as claimed in claim 5 wherein said strip brake comprises a plurality of driven rollers one or more of which include a brake mechanism for engagement with an outer diameter of any strip material wound onto said outer faceplate.

9. A winding apparatus as claimed in claim 3 wherein said rollers comprise bi-directional rollers and further include a drive mechanism for driving said rollers in both directions around said axis R.

10. A winding apparatus as claimed in claim 3 wherein said rollers comprise bi-directional rollers and further include a drive mechanism for driving said rollers in both directions around said axis R and wherein said drive mechanism includes a brake.

11. A winding apparatus as claimed in claim 1 wherein said apparatus further includes a pair of feed rollers mounted on an outer diameter of said outer faceplate for receiving a supply of strip material to said apparatus and for guiding said strip towards said inner faceplate.

12. A winding apparatus as claimed in claim 1 wherein said apparatus further includes a strip clamping and cutting station.

13. A winding apparatus as claimed in claim 1 wherein said inner faceplate further includes a central bore for receiving a supply of core material onto which strip supplied to said apparatus may be wound.

14. A winding apparatus as claimed in claim 13 wherein said apparatus further includes a core supply mechanism for supplying a continuous or semi-continuous supply of core material to said apparatus.

15. A method of forming a tubular article on an apparatus comprising an inner faceplate rotatably mounted for rotation about a longitudinal axis X-X and having an output station thereon; and an outer faceplate radially outward of said inner faceplate; wherein said inner faceplate includes a plurality of inner strip supports at an outer diameter thereof and onto which, in operation, a supply of material may be wound, said outer faceplate includes a plurality of outer supports for supporting a supply of strip material and further includes a drive mechanism for rotating a supply of strip material about said longitudinal axis X-X, the method comprising the steps of:
winding a supply of strip material on said inner supports;
passing a supply of said strip material from an inner diameter thereof through said inner supports to an inner diameter of said inner faceplate; and
rotating said faceplate so as to cause said strip material to be so transferred.

16. A method as claimed in claim 15 and wherein said apparatus includes a strip forming station on said inner faceplate, said method including the step of supplying said strip to said forming station and causing formed strip to be deposited in a spiral fashion so as to form a tubular structure.

17. A method as claimed in claim 15 wherein said outer rollers are driven rollers and the method includes the step of driving said rollers at a speed greater than that of the inner faceplate so as to cause the removal of strip material from an outer diameter S2 thereof and deposit it at an inner diameter S1 supported by said inner supports.

18. A method as claimed in claim 17 wherein said apparatus further includes a strip clamp at an outer diameter of said apparatus and the method includes the further step of slowing the outer diameter S2 and then reversing it so as to allow an otherwise free end of said strip material to be fed back into said clamp and joining a fresh supply of strip material to said otherwise free end.

19. A method as claimed in claim 17 wherein said apparatus further includes a strip clamp at an outer diameter of said apparatus and the method includes the further step of slowing the outer diameter S2 and then reversing it so as to allow an otherwise free end of said strip material to be fed back into said clamp and joining a fresh supply of strip material to said otherwise free end and the method includes the further step of releasing said clamp and causing fresh material to be added to said inner diameter S1 by rotating said inner faceplate.
